(19) United States
(12) Patent Application Publication
(10) Pub. No.: US 2020/0385208 A1
(43) Pub. Date: Dec. 10, 2020

(54) MATERIAL-PROVIDING SYSTEM FOR A MANUFACTURING INSTALLATION

(71) Applicant: Brose Fahrzeugteile SE & Co. Kommanditgesellschaft, Coburg, Coburg (DE)

(72) Inventors: Stefan WOLDRICH, Rödental (DE); Florian WALTER, Coburg (DE)

(73) Assignee: Brose Fahrzeugteile SE & Co. Kommanditgesellschaft, Coburg, Coburg (DE)

(21) Appl. No.: 16/955,969

(22) PCT Filed: Dec. 21, 2018
(86) PCT No.: PCT/EP2018/086581

§ 371 Date: Jul. 22, 2020

(30) Foreign Application Priority Data
Dec. 23, 2017 (DE) 10 2017 131 294.3

(51) Int. Cl. B65G 1/08; B65G 65/00

(52) U.S. Cl. CPC B65G 1/08; B65G 65/00

(57) ABSTRACT

A material-providing system for a manufacturing installation for providing box-shaped load carriers, that is transportable by a driverless transport system. The material-providing system has a rack system having a front side and a rear side, and the rack system forms a magazine shaft, or at least two magazine shafts, for storing load carriers. The at least one magazine shaft extends, starting from the rear side of the rack system, to the front side of the rack system. On the front side of the rack system, the material-providing system has a motorized transfer system for transferring the load carriers to the manufacturing installation, which transfer system is mechanically connected to the rack system and by a transfer system the load carriers can be automatedly removed from the at least one magazine shaft and can be automatedly positioned along the front side of the rack system.

### CROSS-REFERENCE TO RELATED APPLICATIONS

This application is the U.S. National Phase of PCT/EP2018/086581 filed Dec. 21, 2018, which claims priority to German Patent Application No. DE 10 2017 131 294.3 filed Dec. 23, 2017, the disclosures of which are hereby incorporated in their entirety by reference herein.

### TECHNICAL FIELD

The present disclosure relates to a material-providing system for a manufacturing installation.

### BACKGROUND

An interruption-free flow of material is very generally of particular importance in manufacturing installations. Waiting times which are attributed to a delayed or erroneous provision of material are virtually always associated with large economical losses especially in mass manufacturing which has high cycle rates. This is reinforced by the production concepts used nowadays, such as “just-in-time production”, by which the manufacturing process as a whole is streamlined. This streamlining means a material flow which is tightly coordinated with the individually proceeding production process and in which buffer capacities which have hitherto been provided for compensating for irregularities in the material flow are reduced as far as possible. Against this background, concepts for making the material flow more flexible have become known.

### SUMMARY

In one or more embodiments, a substantial aspect is the fundamental consideration that the rack system of the material-providing system itself is assigned a motorized transfer system which serves for transferring the load carriers from the rack system to a manufacturing cell or the like. This gives rise to the possibility of using driverless transport systems, which are cost-effective and are available everywhere in manufacturing, for transporting the material-providing system, and therefore fundamentally a completely automated flow of material can be realized. Ultimately, care merely has to be taken to ensure that the mechanical interfaces between transport system and material-providing system are compatible with one another. In the simplest case, it is even conceivable that the material-providing system according to the proposal is transported semi-automatically or entirely manually, for example by means of a simple lift truck, while the transfer of the load carriers takes place in an automated manner.

In one or more embodiments, on the front side of the rack system, the material-providing system has a motorized transfer system, which is connected mechanically to the rack system, for transferring the load carriers to the manufacturing installation. With the transfer system, the load carriers can be removed from the at least one magazine shaft in an automated manner and can be positioned in transfer positions along the front side of the rack system in an automated manner.

With regard to the rack system of the material-providing system, the reason for this consists in that the entire transfer can be brought about with linear handling movements. With this finding, it is also appropriate for a rack system according to the proposal to always be assigned a dedicated transfer system by the motorized transfer system being connected mechanically to the rack system. The term “connected mechanically” may be understood broadly here and firstly comprises the connection of two components which are separate per se by means of connecting technology in the classical sense. Secondly, this also comprises the configuration of part of the transfer system integrated in the rack system.

The present disclosure permits a flexible configuration of the rack system with magazine shafts which can be arranged one above another and/or next to one another, such as in magazine rows or magazine gaps. The arrangement in magazine rows and magazine gaps permits an exceptionally simple mechanical design of the transfer system, as has been explained above.

According to one or more embodiments, such a mechanically simple design of the transfer system. The transfer system is equipped here with a transfer slide which, in order to remove a load carrier from a magazine shaft as required, can be positioned upstream of the respective magazine shaft. The term “slide” should be understood very generally here to the effect that the movement of the slide is attributed to a displacement in a plane, which in turn can be realized in a structurally easy manner. This plane may be referred to the “movement plane” in which the transfer slide can be moved by means of a positioning drive system.

As an example, the movement plane is oriented parallel to the front side of the rack system, the front side being formed as a flat side, and therefore the transfer of the load carrier from the rack system can be realized with few movement degrees of freedom.

In one or more embodiments, the positioning drive system for moving the transfer slide manages with just two linear units which, may be arranged in a particularly compact construction in the manner of a compound table, i.e. mechanically one on the other.

The advancing of the load carriers toward the front side of the rack system within the at least one magazine shaft is driven by gravity, and is therefore provided cost-effectively, and the shaft bottom of the at least one magazine shaft is then furthermore preferably designed as a roller track or the like. In principle, it can also be provided that a corresponding drive system is also provided for the advance.

In one or more embodiments the removal of the load carriers from the at least one magazine shaft are described herein. The transfer system here has a removal system for removing the load carriers from the at least one magazine shaft and for transferring the load carriers to the transfer slide. As an example, the function of the removal system is simply attributed to a controlled activation or deactivation of a movement limiter for the load carriers, for example in the manner of a controllable end stop. This may be usable in conjunction with the above-discussed, gravity-driven advance of the load carriers in the at least one magazine shaft. Alternatively or additionally, a removal drive system can be provided which ensures a particularly reproducible transfer of the load carriers.

Even if the transfer system according to the proposal is constructed in a very flat manner on the front side of the rack system, the transfer slide has to span a certain distance from the manufacturing cell or the like at least during the transfer. In order to keep the space required by the material-providing system small, such as during the transport thereof, it is preferably provided, according to claim 10, that the transfer slide can be brought into a, preferably space-saving, transport state. In the simplest case, a portion of the transfer slide can be pivoted in in order to take up the transport state.

According to a further teaching, as claimed in claim 11 which obtains independent importance, a manufacturing installation as such is claimed which is equipped with at least one material-providing system according to the proposal.

In a particularly preferred refinement, the manufacturing installation according to the proposal is a manufacturing installation in which the material-providing system according to the invention undertakes a transfer of load carriers to manufacturing cells of the manufacturing installation in an automated manner. Reference should be made to all of the explanations regarding the material-providing system according to the proposal.

A preferred arrangement within the context of the manufacturing installation according to the proposal is the subject matter of claim 12, according to which the manufacturing installation has at least one material-receiving system. Such a material-receiving system may be part of a manufacturing cell which, for the manufacturing, is to be supplied with material. Accordingly, the material-receiving system has a receiving unit or a plurality of receiving units for load carriers. The material-providing system according to the proposal serves for the automated transfer of load carriers to the material-receiving system. For this purpose, it is provided that the material-providing system is transported upstream of the material-receiving system, here and preferably by means of a driverless transport system, and the load carriers stored in the at least one magazine shaft of the material-providing system can be transferred to the at least one receiving unit of the material-receiving system by means of the transfer system. Of particular advantage here, as claimed in claim 13, is the fact that the respectively removed load carrier can be positioned in a flexible manner in the respectively desired receiving position by means of the transfer slide. This enables the load carrier concerned to be transferred to an optimum receiving position in such a manner that manual handling for providing the load carriers is no longer required.

According to a further teaching as claimed in claim 14 which likewise obtains independent importance, the use of a material-providing system according to the proposal for providing the above load carriers in a manufacturing installation is claimed. Also to this extent, reference should be made to all of the explanations regarding the material-providing system according to the proposal and in particular regarding the manufacturing installation according to the proposal.

### BRIEF DESCRIPTION OF THE DRAWINGS

The invention will be explained in more detail below with reference to a drawing which illustrates just one exemplary embodiment. In the drawing

FIG. 1 shows a manufacturing installation according to the proposal with a material-providing system according to the proposal, in a top view,

FIG. 2 shows the material-providing system according to FIG. 1 in a perspective view,

FIG. 3 shows the material-providing system and the material-receiving system according to FIG. 1 in the region III in an expanded view, and

FIG. 4 shows the material-providing system according to FIG. 1 according to a further embodiment in a perspective view and in three detailed views A, B, C which, in their sequence, represent the transfer of a load carrier.

### DETAILED DESCRIPTION

A known material-providing system is described in DE 20 2011 003 546 U1, this material-providing system can be transported as such by means of a motorized transport system. The material-providing system transportable in such a manner comprises a rack system with magazine shafts for storing box-shaped load carriers. The transport system is additionally assigned a handling unit with which load carriers stored in the rack system can be transferred, for example, to a manufacturing cell or the like.

Although the known material-providing system brings about an increase in flexibility in respect of the material flow in a manufacturing installation, this advantage is bought by a complicated integrated transport and handling system.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The material-providing system 1 illustrated in the drawing is preferably used in an, such as linked, manufacturing installation 2 and serves there for providing load carriers 3 which here and preferably are boxed-shaped, such as for transferring the load carriers 3 to manufacturing cells 4, 5 of the manufacturing installation 2. The load carriers 3 contain material which is to be supplied to the manufacturing cells 4, 5, within the scope of the flow of material.

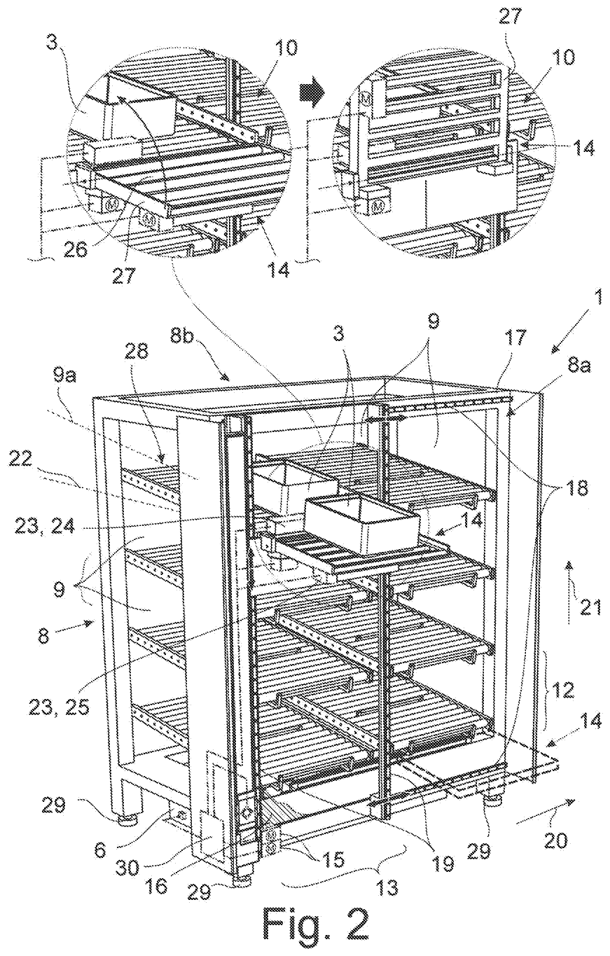

It can be gathered from the illustration according to FIG. 2 that the material-providing system 1 as such is transportable by means of a driverless transport system 6. This gives rise to the possibility of automating the provision of material with different degrees of automation up to the fully automated provision of material. Here and preferably, the transport system 6 can therefore be coupled to the material-providing system 1 merely for transport and is not an integral part of the material-providing system 1, thus resulting in the capability of implementing the material-providing system 1 cost-effectively. In principle, however, the transport system 6 may also be an integral part of the material-providing system 1.

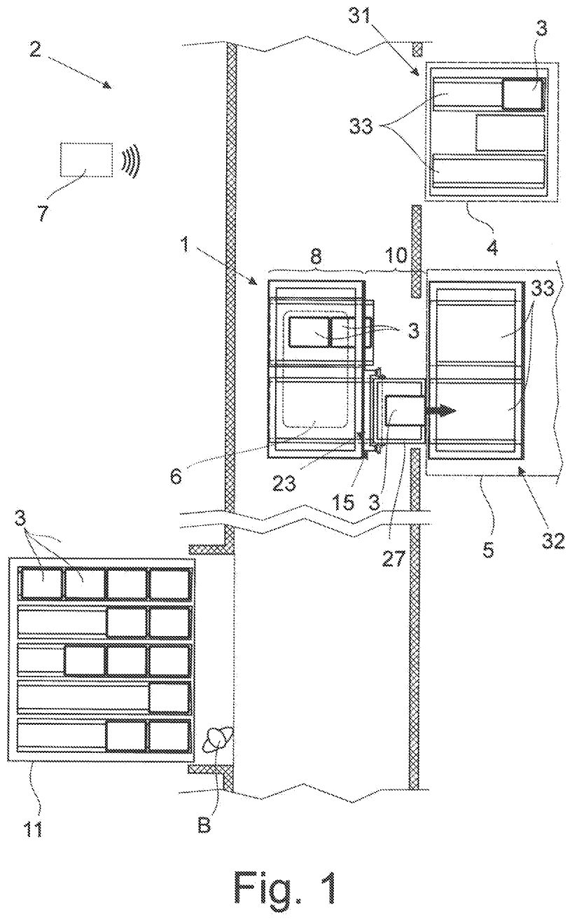

The manufacturing installation 2 is assigned a control system 7 that is indicated in FIG. 1 and outputs corresponding commands to the components of the manufacturing installation 2. A radio-based communication with the control system 7 is indicated in FIG. 1 for a simple illustration.

FIG. 2 shows that the material-providing system 1 has a rack system 8 having a front side 8a and a rear side 8b and which forms at least one magazine shaft 9, preferably at least two magazine shafts 9, for storing load carriers 3. In the exemplary embodiment which is illustrated and is to this extent preferred, more than two magazine shafts 9, namely a total of eight magazine shafts 9, are provided. The number of magazine shafts 9 can be selected depending on the boundary conditions in terms of the flow of material. When the discussion here concerns a plurality of magazine shafts 9, these explanations apply correspondingly to a configuration having only a single magazine shaft 9.

The magazine shafts 9 extend to the front side 8a of the rack system 8 such that the load carriers 3 can be removed from the front side 8a. The magazine shafts 9 preferably extend from the rear side 8b of the rack system 8 to the front side 8a of the rack system 8. Filling of the magazine shafts 9 with load carriers 3 from the rear side 8b of the rack system 8 is therefore possible.

The filling of the material-providing system 1 takes place here and preferably via a central store 11 which is likewise designed in the manner of racks. The filling of the material-providing system 1 can be provided in an automated manner or, as indicated in FIG. 1, manually by an operator B. In the exemplary embodiment illustrated, in addition to the filling of the material-providing system 1, the central store 11 also serves for returning load carriers 3 emptied over the course of the manufacturing and which are summarized here under the term “empties”.

As an example, on the front side 8a of the rack system 8, the material-providing system 1 has a motorized transfer system 10, which is connected mechanically to the rack system 8, for transferring the load carriers 3 to the manufacturing installation 2. The transfer of the load carriers 3 to the manufacturing cells 4, 5 is therefore meant here.

As an example, the transfer system 10 is assigned two functions. The first function of the transfer system 10 consists in that the load carriers 3 can be removed from the magazine shafts 9 in an automated manner with the transfer system 10. The second function of the transfer system 10 consists in that the removed load carriers 3 can be positioned along the front side 8a of the rack system 8 in an automated manner with the transfer system 10. The respectively removed load carrier 3 can therefore be positioned by means of the transfer system 10 at a position of the manufacturing cell 4, 5 that is intended for the transfer, and therefore manual handling can be completely omitted.

FIG. 2 furthermore shows that the magazine shafts 9 are arranged one above another and next to one another, as seen from the front side 8a of the rack system 8, and therefore the magazine shafts 9 form magazine rows 12 and magazine gaps 13, as seen from the front side 8a of the rack system 8.

In principle, however, it may also be provided that the magazine shafts 9 are arranged exclusively one above another or exclusively next to one another. In all of these cases, the rack system 8 is preferably in the shape of a cuboid.

It can best be gathered from the illustration according to FIG. 2 that the transfer system 10 has a transfer slide 14, and, in order to remove a load carrier 3 from a magazine shaft 9, the transfer slide 14 can be positioned upstream of the respective magazine shaft 9 at a magazine position assigned to the magazine shaft 9. A first position of the transfer slide 14 is illustrated by a solid line in FIG. 2 while a second position of the transfer slide 14 is illustrated by a dashed line in FIG. 2.

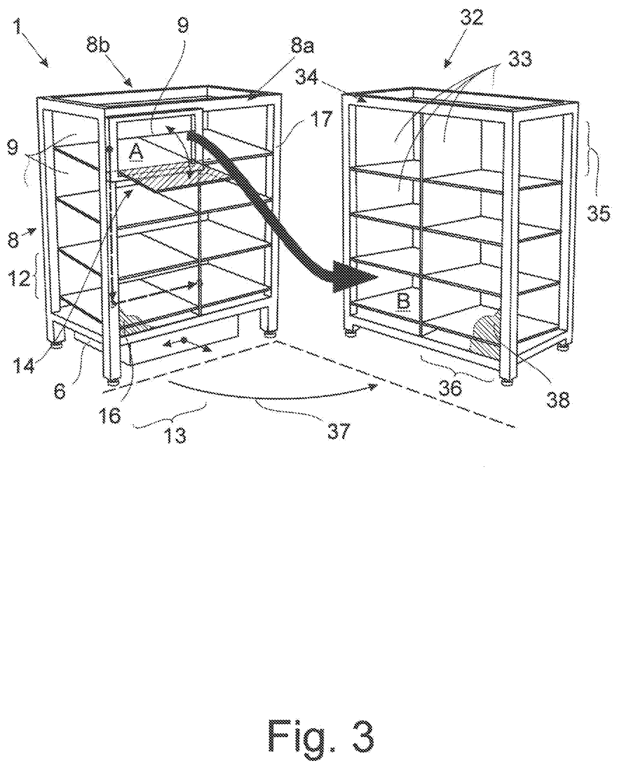

The transfer slide 14 is preferably assigned a positioning drive system 15 (not illustrated in FIG. 3) for the positioning of the transfer slide 14 receiving the respective load carrier 3 in a, here and preferably vertically oriented, movement plane 16. Furthermore preferably, the transfer slide 14 is movable in two movement degrees of freedom, which have yet to be explained, in the movement plane 16 by means of the positioning drive system 15. The positioning drive system 15 is preferably an electric drive system.

It emerges from the illustration according to FIG. 2 that the movability of the transfer slide 14 is adapted particularly readily to the geometry of the rack system 8. This arises such as from the fact that the rack system 8 has a frame 17 which forms the front side 8a of the rack system 8 as a flat side, and that the movement plane 16 is oriented parallel to the front side 8a, configured as a flat side, of the rack system 8. It can basically be provided here that the transfer system 10 is arranged on the frame 17 of the rack system 8. However, here and preferably, the transfer system 10 forms at least part of the frame 17 of the rack system 8.

In an exemplary embodiment, the positioning drive system 15 is designed particularly simply. This is because the positioning drive system 15 has merely an X linear unit 18 and a Y linear unit 19, by means of which the transfer slide 14 is movable in the movement plane 16 in an X direction 20 and perpendicularly thereto in a Y direction 21. The X direction 20 corresponds to a horizontal direction while the Y direction 21 corresponds to a vertical direction.

In the material-providing system 1 illustrated, the X linear unit 18 is immovable in relation to the rack system 8 while the Y linear unit 19 as such is displaceable relative to the rack system 8 via the X linear unit 18. The fact that the transfer slide 14 is arranged on the Y linear unit 19 results in the transfer slide 14 being correspondingly able to move both in the X direction 20 and in the Y direction 21. This results overall in the arrangement of a two-axis system, such as with an arrangement of the linear units 18, 19 in the manner of a compound table. It should be pointed out that the above axis arrangement can basically also be provided the other way around.

The advance of the load carriers 3 forward, i.e. toward the front side 8a of the rack system 8, is achieved in a particularly simple structural manner in the exemplary embodiment which is illustrated and to this extent preferred. Here, the longitudinal axes 9a of the magazine shafts 9 are oriented at an inclination in relation to the horizontal 22, and therefore the load carriers 3 are advanced in the magazine shafts 9 in a manner driven by gravity. Furthermore preferably, the load carriers 3, as shown in FIG. 2, can be stored one behind another in an abutting manner in the magazine shafts 9. In order to reduce the susceptibility to faults during the advancing of the load carriers 3, the shaft bottoms 28 of the magazine shafts 9 are formed by transport tracks, such as by roller tracks or the like. In principle, it can also be provided that the transport tracks assigned to the magazine shafts 9 are driven in order to configure the advancing of the load carriers 3 in as reproducible a manner as possible.

For the removal of the load carriers 3 from the magazine shafts 9 and for the transfer of the load carriers 3 to the transfer slide 14, on the at least one magazine shaft 9 and/or on the transfer slide 14 the transfer system 10 is equipped with a motorized removal system 23 (not illustrated in FIG. 3). In the exemplary embodiment which is illustrated and is to this extent preferred, both variants are realized. The magazine shafts 9 are each assigned a movement limiter 24 for the load carriers 3 that limits the advance at least of the respective frontmost load carrier 3 in the magazine shafts 9, and the movement limiter 24 can be deactivated by means of the removal system 23 for the removal of the load carriers 3. For example, the movement limiter 24 can be an end stop which prevents an excessive advancing of the load carriers 3 toward the front side 8a of the rack system 8 but which can be deactivated by means of the removal system 23 for the removal of the load carriers 3 by being moved in a motorized manner out of the range of movement of the load carriers 3.

In addition, in the removal system 23 has an such as electric removal drive system 25 with which the respective frontmost load carrier 3 in the magazine shafts 9 can be transferred to the transfer slide 14. Here and preferably, the transfer slide 14 has a transport track 26, such as roller track, for the load carriers 3, the transport track being driven by the removal drive system 25. It is therefore additionally possible for the respectively removed load carrier 3 to be advanced in a motorized manner in the direction of the manufacturing cell 4, 5, which increases the reproducibility during the transfer of the respective load carrier 3.

Owing to the fact that the load carriers 3, as discussed above, are arranged one behind another in an abutting manner in the magazine shafts 9, it is additionally required for each magazine shaft 9 to have a separating system, not illustrated, which holds back the following load carriers 3 when the frontmost load carrier 3 is removed. This can be realized, for example, by an additional movement limiter being provided which prevents the load carrier 3 following the frontmost load carrier 3 from advancing until the frontmost load carrier 3 is completely received by the transfer slide 14.

The two detailed views according to FIG. 2 show that the transfer slide 14 can be brought into a transfer state (left detailed view) and into a transport state (right detailed view). It is provided specifically that the transfer slide 14 has a receiving portion 27 for the respectively removed load carrier 3, the receiving portion providing the transport track 26 which is discussed above and is provided in the preferred refinement. The receiving portion 27 can now furthermore be pivoted in relation to the transfer slide 14 into a transfer position (left detailed view) and into a transport position (right detailed view). In the transfer state, the receiving portion 27 adjoins the shaft bottom 28 of the respective magazine shaft 9. This means in very general terms that the receiving portion 27 provides a continuation of the shaft bottom 28 in the direction of the manufacturing cells 4, 5, and a gap can remain between shaft bottom 28 and receiving portion 27 if the gap is more substantially smaller than the extent of the load carriers 3 in the advancing direction.

The right detailed view according to FIG. 2 shows that the receiving portion 27 is pivoted in in the transport state and therefore assumes a substantially vertical orientation. This is a way of accommodating the receiving portion 27 in a particularly space-saving manner during the transport of the material-providing system 1 according to the proposal.

It has already been explained further above that the transportability of the material-providing system 1 according to the proposal can be provided in different ways. The material-providing system 1 can preferably be moved under by a driverless transport system 6 and raised at least slightly for transport. This can be gathered from the illustration according to FIG. 2. The material-providing system 1 has a series of standing feet 29, and therefore the material-providing system 1, when required, such as for the transfer of load carriers 3, can be set down and the driverless transport system 6 can be used in some other way.

Different embodiments may provide control structure of the material-providing system 1 according to the proposal. In the exemplary embodiment which is illustrated in FIG. 2 and is to this extent preferred, the material-providing system 1 is assigned a dedicated control 30 which has at least one driver stage for the electric drive components of the material-providing system 1. In principle, the control 30 can also provide a sequence control for the material-providing system 1. Furthermore alternatively, it can be provided that a control of the driverless transport system 6 takes on control tasks for the material-providing system 1.

The energy supply of the electric drive components of the material-providing system 1 can stem from the fact that the material-providing system 1 has an energy store, not illustrated, for storing electrical energy, such as an electric battery. Alternatively, the energy required such as for the drive components can be provided by the driverless transport system 6 or by the manufacturing cells 4, 5 via an electric interface.

In this respect, it may be advantageous for the material-providing system 1 to very generally have an electric interface for transmitting electrical energy and/or for data transmission, the interface being able to be brought into electrical engagement with a mating interface on the driverless transport system 6 and/or on the manufacturing cells 4, 5.

The manufacturing installation 2 which is the subject matter of an independent teaching will be examined as such in more detail below. It is first of all assumed here that, in addition to the material-providing system 1 illustrated, at least one further material-providing system 1 can be provided.

Furthermore, in the manufacturing installation 2 which is illustrated and is to this extent preferred, the existence of at least one material-receiving system 31, 32, which interacts with the material-providing system 1 is of importance. The manufacturing installation 2 illustrated has two manufacturing cells 4, 5 which are respectively equipped with a material-receiving system 31, 32.

The explanations below relate primarily to the material-receiving system 32 of the manufacturing cell 5. All of the explanations in this regard apply correspondingly to the material-receiving system 31 of the manufacturing cell 4. In both cases, the material-receiving system 31, 32 serves for receiving the load carriers 3 from the material-providing system 1, and therefore the respective manufacturing cell 4, 5 is supplied with the material, which is provided in the load carriers 3, for the manufacturing.

The material-receiving system 31, 32 has at least one receiving unit 33, preferably at least two receiving units 33, and a total of eight receiving units 33 in the exemplary embodiment illustrated in FIG. 3. The receiving units 33 can be realized in different ways. In the exemplary embodiment which is illustrated in FIG. 3 and is to this extent preferred, the receiving units 33 are configured as magazine shafts, as is provided in the material-providing system 1 according to the proposal.

The material-providing system 1 can be transported here upstream of the material-receiving system 32 by means of the driverless transport system 6, and the load carriers 3 stored in the magazine shafts 9 of the material-providing system 1 can be transferred to the at least one receiving unit 33, here to the receiving units 33, by means of the transfer system 10.

It can be gathered from the illustration according to FIG. 3 that the receiving units 33 configured here and preferably as magazine shafts are arranged one above another and next to one another, as seen from a front side 34 of the material-receiving system 32, and therefore the receiving units 33 form magazine rows 35 and magazine gaps 36, as explained above in conjunction with the material-providing system 1. Apart from the lack of a transfer system 10, the basic structure of the material-receiving system 32 corresponds to the basic structure of the material-providing system 1.

FIG. 3 shows the material-providing system 1 located upstream of the material-receiving system 32, and the illustration according to FIG. 3 is an expanded view. This is indicated in FIG. 3 by the arrow 37.

When the material-providing system 1 is located upstream of the material-receiving system 32, the transfer slide 14, for transfer of the load carrier 3 removed from a magazine shaft 9 to a receiving unit 33 of the magazine-receiving system 32 can be positioned by means of the positioning drive system 15 in a receiving position assigned to the receiving unit 33. The receiving positions here and preferably lie in a receiving plane 38 which is assigned to the material-receiving system 32 and is positioned parallel to the above-discussed movement plane 16 of the material-providing system 1. This requires the material-providing system 1 to have been correspondingly oriented in relation to the material-receiving system 32. The orientation can take place on the basis of a sensor, for example by the driverless transport system 6 having a sensor-based orientation control which orients the driverless transport system 6 with respect to orientation marks, not illustrated, of the manufacturing cells 4, 5. However, it is also conceivable that, for the orientation, recourse is made to navigation data, such as GPS navigation data, of the driverless transport system 6, which data are compared with the CAD data, stored in the control system 7, of the manufacturing installation 2.

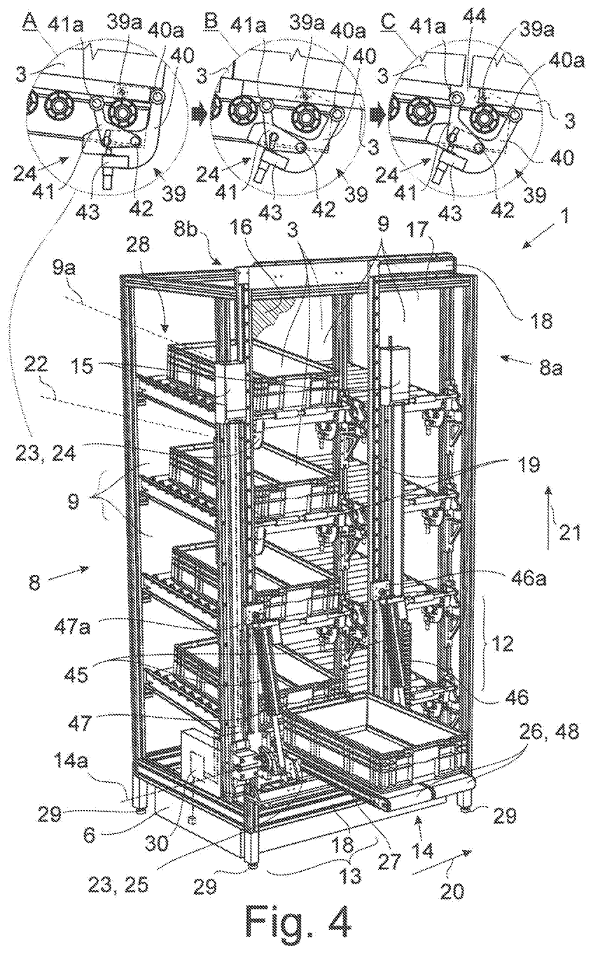

The illustration according to FIG. 4 shows a material-providing system 1 according to the proposal in a further preferred embodiment. The three detailed views A, B, C in their sequence represent the transfer of a load carrier 3 via the transfer slide 14.

In terms of the basic design and in terms of the basic operation, the material-providing system 1 illustrated in FIG. 4 corresponds to the material-providing system 1 shown in FIGS. 2 and 3. To this extent, reference should be made to all of the explanations regarding the embodiment illustrated in FIGS. 2 and 3.

In the material-providing system 1 shown in FIG. 4, differences are shown in the realization of the movement limiter 24 for the load carriers 3 and in the realization of the adjustability of the transfer slide 14 between the transfer state and the transport state. The structural details regarding the differences will be explained in detail below.

In the material-providing system 1 that is illustrated in FIG. 4, the movement limiter 24 itself is configured as a separating system discussed further above. This means that, by appropriate activation of the movement limiter 24, the load carriers 3 which are arranged one behind another in the magazine shaft 9 are issued to the transfer slide 14 in a correspondingly separated manner. For this purpose, the movement limiter 24 has a preferably fork-shaped separator 39. The separator 39 has a first separating leg 40 and a second separating leg 41 which are respectively equipped with an associated limiter element 40a, 41a for limiting the advance of the load carriers 3. The limiter elements 40a, 41a are here and preferably equipped with rollers over which the load carriers 3 can roll.

The separator 39 can pivot at least with the first separating leg 40 about the pivot axis 39a between a blocking position (view A in FIG. 4) and a release position (view B in FIG. 4). For this purpose, the separator 39 is assigned a preferably electric drive system, not illustrated.

When a magazine shaft 9 is free from load carriers 3, an adjustment of the first separating leg 40 into the release position is associated with the first separating leg 40 pivoting out of the magazine shaft 9 and the second separating leg 41 pivoting into the magazine shaft 9. Conversely, an adjustment of the first separating leg 40 into the blocking position is associated with the first separating leg 40 pivoting into the magazine shaft 9 and the second separating leg 41 pivoting out of the magazine shaft 9.

The second separating leg 41 is coupled pivotably to the first separating leg 40 via the pivot axis 42. The two separating legs 40, 41 are spring-pretensioned in relation to each other. A spring arrangement 43 is provided for this purpose.

The arrangement has now been implemented in such a manner that, in the blocking position, the limiter element 40a of the first separating leg 40 blocks the frontmost load carrier 3 against further advance in the direction of the transfer slide 14. This can be gathered in the illustration according to view A in FIG. 4.

The release of the frontmost load carrier 3 in the direction of the transfer slide 14 is initiated by the first separating leg 40 being adjusted in a motorized manner into the release position. This is associated with the limiter element 40a of the first separating leg 40 pivoting out of the magazine shaft 9, i.e. out of the path of movement of the frontmost load carrier 3. Via the above spring arrangement 43, the second separating leg 41 first of all follows the adjustment of the first separating leg 40, which, if the frontmost load carrier 3 is missing, would lead to the second separating leg 41 pivoting into the path of movement of the load carriers 3. However, this pivoting in of the second separating leg 41 is blocked by the lower side of the frontmost load carrier 3, and therefore the pivoting out of the first separating leg 40 is associated with the spring arrangement 43 being deflected and, as a result, the second separating leg 41 being pressed against the lower side of the load carrier 3.

Owing to the fact that the frontmost load carrier 3 is now released from the first separating leg 40 and the limiter element 40a thereof, the frontmost load carrier 3 moves in the direction of the transfer slide 14. The following load carrier 3 is prevented from further advance by the second separating leg 41 by the second separating leg 41, driven by the spring arrangement 43, snapping into the path of movement of the following load carrier 3.

As soon as the load carrier 3 which has just been released has passed the first separating leg 40, the first separating leg 40 is adjusted in a motorized manner back into the blocking position, and therefore the second separating leg 41 is pivoted out of the path of movement of the following load carrier 3 and the first separating leg 40 is pivoted into the path of movement of the following load carrier 3. Subsequently, the following load carrier 3 can be advanced as far as the first separating leg 40 and can be blocked there by the limiter element 40a.

A requirement for the operation of the above-discussed separating system consists in that two consecutive load carriers 3 at the contact point on the lower side form a free region 44 into which the second separating leg 41 can pivot, such as, as discussed above, can snap in a spring-driven manner, during the advance of the load carriers 3 according to view C in FIG. 4.

The separating system according to the proposal permits robust separation of the load carriers 3 with a simple structural design. Furthermore, the activation of the drive system assigned to the separating system is associated with a low outlay, because of the above-discussed, automatic snapping in of the second separating leg 41.

A second advantageous aspect of the embodiment illustrated in FIG. 4 consists in the motorized pivotability of the receiving portion 27 of the receiving slide 14 about the pivot axis 14a into the transfer position and into the transport position. In the transport position which is started up in a motorized manner, the receiving portion 27 assumes a substantially vertical orientation. As discussed above, this is a particularly space-saving way of accommodating the receiving portion 27 during the transport of the material-providing system 1 according to the proposal.

For the motorized adjustment of the receiving portion 27, the transfer slide 14 is assigned a drive system 45, by means of which the receiving portion 27 can be pivoted in a motorized manner between the transfer position and the transport position. The drive system 45 has two linear drives 46, 47 which act on opposite sides of the receiving portion 27. In principle, just one linear drive 46, 47 can also be provided here.

The respective linear drive 46, 47 is supported on a counterbearing 46a, 47a which here and preferably acts on that part of the transfer slide 14 to which the receiving portion 27 is coupled. The respective linear drive 46, 47 can be configured, for example, as a spindle drive, as a pneumatic piston-cylinder drive or the like.

The material-providing system 1 shown in FIG. 4 is also distinguished in that the transfer slide 14 has a transport track 26 for the load carriers 3, the transport track being driven by the removal drive system 25 and here and preferably forming a moving belt arrangement 48. This results in a particularly slip-free advancing of the load carriers 3 over the transfer slide 14.

Furthermore, as discussed above, reference should be made in respect of the configuration and operation of the material-providing system 1 illustrated in FIG. 4 to all of the explanations regarding the material-providing system 1 illustrated in FIGS. 2 and 3.

Finally, the use according to the proposal of the material-providing system 1, which use is the subject matter of an independent teaching, will now be explained with reference to the scenario illustrated in FIGS. 1 and 3.

For the use according to the proposal of the material-providing system 1, the latter is first of all transported upstream of the material-receiving system 32. This may comprise an orientation in the above sense. For example, it is specified by the control system 7 that the frontmost load carrier 3 in the magazine shaft 9 identified by reference sign A in FIG. 3 is intended to be transferred to the receiving unit 33, identified by reference sign B. For this purpose, the relevant load carrier 3 is removed from the magazine shaft 9 by means of the removal system 23, as a result of which the load carrier 3 reaches the receiving portion 27 of the transfer slide 14. Subsequently, the transfer slide 14 is moved by means of the positioning drive system 15 downward by three magazine shafts 9 and by one magazine shaft 9 to the side. In very general terms, this means that the transfer slide 14 is positioned for transferring the load carrier 3 removed from the relevant magazine shaft 9 to the relevant receiving unit 33 of the material-receiving system 32. It can be gathered from the illustration according to FIG. 3 that, with the solution according to the proposal, a virtually unlimited distribution of load carriers 3 to the material-receiving systems 31, 32 is possible.

The material-providing system 1 according to the proposal, the manufacturing installation 2 according to the proposal and the use according to the proposal can be modified and extended within wide ranges.

For example, the material-providing system 1 can be filled manually or in an automated manner with empties in the above sense and the empties can be discharged to the central store 11 or to an empties store specially provided for this purpose.

Finally, it can basically also be provided that the material-providing system 1 additionally has, on the rear side 8b of the rack system 8, an above-explained motorized transfer system with which the material-providing system 1 can be filled in an automated manner with load carriers 3. This is a preferred variant which permits a fully automated flow of material in a particularly simple manner.

However, automated filling of the material-providing system 1 is possible even without an additional transfer system. For example, it is conceivable for an issuing store, the central store 11, to have magazine shafts which are arranged identically relative to one another compared to the magazine shafts 9 of the material-providing system 1. The filling of the material-providing system 1 is then limited to the material-providing system 1 being transported upstream of the issuing store, the central store 11, and to the load carriers 3 located in the magazine shafts of the issuing store being released. The subsequent transfer of the load carriers 3 preferably takes place automatically, in a gravity-based manner.

Another variant for automated filling of the material-providing system 1 consists in that a handling apparatus that is separate from the material-providing system 1 is arranged between the issuing store, such as the central store 11, and the material-providing system 1 that is transported upstream of the issuing store. The handling apparatus may be a robot, such as a gantry robot, an articulated robot or the like. Other variants for the automated filling of the material-providing system 1 with load carriers 3 are conceivable.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### PARTS LIST

1 material—providing system

2 manufacturing installation

3 load carriers

4 manufacturing cells

5 manufacturing cell

5 respective manufacturing cell

6 driverless transport system

7 control system

8 rack system

9 magazine shafts

10 transfer system

11 central store

12 form magazine rows

13 magazine gaps

14 transfer slide

14 slide

15 positioning drive system

16 movement plane

17 frame

18 linear units

19 Y linear unit

20 X direction

21 Y direction

22 horizontal

23 removal system

24 movement limiter

25 electric removal drive system

26 transport track

27 portion

28 shaft bottom

29 standing feet

30 control

31 material—receiving system

32 material—receiving system

33 two receiving units

34 front side

35 form magazine rows

36 magazine gaps

37 arrow

38 plane

39 separator

40 separating legs

41 second separating leg

42 pivot axis

43 spring arrangement

44 free region

45 drive system

46 linear drive

47 linear drives

48 moving belt arrangement

8a front side

8b rear side

9a longitudinal axes

14a pivot axis

39a pivot axis

40a limiter elements

41a limiter elements

46a counterbearing

47a counterbearing

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A material-providing system for use in a manufacturing installation and configured to provide load carriers, the material providing system comprising:
a driverless transport system configured to transport the material providing system;
a rack system provided with a front side and a rear side, and forming a magazine shaft extending between the front side and the rear side and configured to store the load carriers;
a motorized transfer system mechanically connected to the rack system and configured to, in an automated manner, transfer the load carriers from the magazine shaft to the front side of the rack system and transfer the load carriers from the magazine shaft to the manufacturing installation.

2. The material-providing system of claim 1, wherein the rack system forms a number of magazine shafts each arranged one above another and/or next to one another, with respect to the front side of the rack system so that the number of magazine shafts form magazine rows and magazine gaps visible from the front side of the rack system.

3. The material-providing system of claim 1, wherein the motorized transfer system includes a transfer slide positioned upstream of the magazine shaft, and operable to receive and remove the load carrier from the magazine shaft.

4. The material-providing system of claim 3, wherein the transfer slide is provided with a positioning drive system configured to position the transfer slide to receive the load carrier, wherein the positioning drive system is configured to move the load carrier along a vertically oriented movement plane so that the transfer slide is movable in two movement degrees of freedom in the movement plane.

5. The material-providing system of claim 4, wherein the rack system includes a frame forming the front side of the rack system, wherein the front side is flat, and the vertically oriented movement plane is oriented parallel to the front side.

6. The material-providing system of claim 5, wherein the positioning drive system includes an X linear unit and a Y linear unit, each configured to move the transfer slide along the movement plane in an X direction and a Y direction, respectively, wherein the X direction is perpendicular to the Y direction, and wherein the X linear unit and the Y linear unit are arranged to form a compound table.

7. The material-providing system of claim 1, wherein a longitudinal axis of the magazine shaft is oriented at an inclination with respect to a horizontal line extending between the front side and the rear side so that a number of load carriers stored one behind another advance from a rear side of magazine shaft to a front side of the magazine shaft by a force of gravity.

8. The material-providing system of claim 1, wherein the motorized transfer system includes a motorized removal system disposed on the magazine shaft and/or on the transfer slide and is configured to remove the load carrier from the magazine shaft and transfer the load carriers from the magazine shaft to the transfer slide.

9. The material-providing system of claim 8, further comprising a movement limiter disposed in the magazine shaft and configured to limit a a forward most load carrier configured to be deactivated by means of the motorized removal system.

10. The material-providing system of claim 1, wherein the transfer slide is configured to change to a transfer state and to a transport state, and includes a receiving portion configured to receive a load carrier removed from the magazine shaft, and pivot with respect to the transfer slide to a transfer position and to a transport position, and wherein when the transfer slide is in the transfer state, the receiving portion adjoins a shaft bottom of the respective magazine shaft.

11. A manufacturing installation having at least one material-providing system of claim 1.

12. The manufacturing installation of claim 11, wherein the manufacturing installation includes a material-receiving system provided with a receiving unit configured to receive a number of load carrier, transferred from the material-providing system by the transfer system.

13. The manufacturing installation of claim 12, wherein, when the material-providing system is located upstream of the material-receiving system, the transfer slide is configured to be positioned by means of the positioning drive system to a number of receiving positions to transfer a load carrier, of the number of load carriers, removed from the magazine shaft to the receiving unit and wherein the receiving positions lie in a receiving plane defined by the material-receiving system.

14. (canceled)

15. (canceled)

16. The material-providing system of claim 9, wherein the removal system is provided with a removal drive system and the transfer slide is provided with a transport track configured to be driven by the removal drive system wherein the removal drive system is configured to transfer the forward most load carrier from the magazine shaft to the transfer slide.

17. A material providing system for use in a manufacturing installation, the material providing system comprising:
a rack system provided with a front side and a rear side, and forming a magazine shaft extending between the front side and the rear side and configured to receive a number of load carriers;
a motorized transfer system mechanically connected to the rack system and including,
a shaft bottom extending between the rear side and the front side configured to move a load carrier of the number of load carriers to the front side of the rack system,
a first separator leg pivotable about a first pivot axis by a motor between a first position and a second position, and
a second separator leg pivotable between a third position and a fourth position, wherein when the first separator leg is in the first position, the first separator leg is configured to block a first load carrier, of the number of load carriers, from moving away from the rear side of the rack system, and when the first separator leg is in the second position, the first separator leg is configured to release the first load carrier and the second separator leg moves from the third position to the fourth position to block a second load carrier, of the number of load carriers and positioned closer to the rear side of the rack system than the first load carrier.

18. The material providing system of claim 17, further comprising a spring arrangement operatively connected to the first separating leg and the second separating leg so that as the first separating leg moves from the first position to the second position, the second separating leg moves from the third position to the fourth position.

19. The material providing system of claim 17, wherein the first separating leg and/or the second separating leg includes a roller so that as the first load carrier moves away from the rear side of the rack system the load first load carrier rolls over the roller.

20. The material providing system of claim 17, further comprising:
a transfer slide configured to receive the first load carrier from the magazine shaft; and
a linear drive configured to move the transfer slide between the magazine shaft and a number of other magazine shafts disposed above or below the magazine shafts.

21. The material providing system of claim 20, wherein the transfer slide is pivotable between a transport position and a transfer position, wherein when the transfer slide is in the transport position, the transfer slide is positioned perpendicular to the shaft bottom to prevent movement of the first load carrier as the rack system is transported by the driverless transport system.

22. The material providing system of claim 21, wherein when the transfer slide is in the transfer position, the transfer slide is positioned to receive the first load carrier from the magazine shaft.
